(19) United States
(12) Patent Application Publication
(10) Pub. No.: US 2023/0359040 A1
(43) Pub. Date: Nov. 9, 2023

(54) LIGHTGUIDE OF EYEWEAR APPARATUS, EYEWEAR APPARATUS AND OPERATIONAL AND MANUFACTURING METHOD OF LIGHTGUIDE

(71) Applicant: DISPELIX OY, Espoo (FI)

(72) Inventors: Toni Saastamoinen, Espoo (FI); Hanna Lajunen, Espoo (FI); Juuso Olkkonen, Espoo (FI)

(73) Assignee: DISPELIX OY, Espoo (FI)

(21) Appl. No.: 18/246,361

(22) PCT Filed: Oct. 12, 2021
(86) PCT No.: PCT/FI2021/050677

§ 371 Date: Mar. 23, 2023

(30) Foreign Application Priority Data
Oct. 14, 2020 (FI) 20206006

(51) Int. Cl. G02B 27/01; G02B 6/34

(52) U.S. Cl. CPC G02B 27/0172; G02B 6/34; G02B 2027/0123

(57) ABSTRACT

A lightguide of an augmented or virtual reality eyewear apparatus (10) comprises an additional grating (110) arranged between an in-coupling grating (102) and an out-coupling grating (104). The additional grating (110) comprises grating areas (112, 112′, 114, 114′), at least two of which have a common physical interface (116) and grating vectors of different directions. The grating vectors of the additional grating (110), the in-coupling grating (102) and the out-coupling grating (104) are linear combinations of two non-parallel and common base vectors, and a sum of the grating vectors of the in-coupling grating (102), the additional grating (110) and the out-coupling grating (104) is zero separately for each optical path, which guides light from the in-coupling grating (102) via the additional grating (110) to the out-coupling grating (104) and allows the light to be coupled out from the out-coupling grating (104).

### FIELD

The invention relates to a lightguide of an augmented or virtual reality eyewear apparatus, an augmented or virtual reality eyewear apparatus and an operational and manufacturing method of the lightguide.

### BACKGROUND

When using an augmented reality (AR) or virtual reality (VR) eyewear based on diffraction, light of a visible range is coupled into a lightguide through an in-coupling diffractive grating, and after the light is distributed inside the lightguide, it is out-coupled through an out-coupling diffractive grating such that a user sees the image that is received by the first diffractive grating. In addition to the digital representation, the augmented reality eyewear also allows to see the surrounding environment through the lightguide.

An exit-pupil expander (EPE) has been used between the input coupling and the output coupling within lightguide to distribute in-coupled light over a larger area before out-coupling. Also rotation angles between the gratings and grating periods have been adjusted in order to control the area and the shape of the lightguide. However, the addition of an EPE within the lightguide results in a large surface area of the lightguide because the lightguide should guide all rays efficiently to the out-coupling area. The increased area also caused problems to the shape and design of the eyewear, and how to locate the in-coupling and out-coupling with respect to each other. Hence, an improvement would be welcome.

### BRIEF DESCRIPTION

The present invention seeks to provide an improvement for the eyewear.

The invention is defined by the independent claims. Embodiments are defined in the dependent claims.

### LIST OF DRAWINGS

Example embodiments of the present invention are described below, by way of example only, with reference to the accompanying drawings, in which

FIGS. 1A and 1B illustrate examples of an augmented reality eyewear

FIG. 2 illustrate an example of a lightguide of an augmented or virtual reality eyewear apparatus seen from above;

FIG. 3 illustrates an example of a lightguide seen from above;

FIG. 4 illustrates an example of another lightguide seen from above;

FIG. 5 illustrates an example of still another lightguide seen from above;

FIG. 6 illustrates a further example of a lightguide seen from above;

FIG. 7 illustrates an example of a lightguide in perspective;

FIG. 8 illustrates an example how a lightguide with grating areas of the additional grating guide light;

FIG. 9 illustrates of an example of where the lightguide comprises a plurality of grating areas;

FIG. 10 illustrates of an example of similar to that of FIG. 9 except that the in-coupling grating is separated with a physical distance from the additional grating and the out-coupling grating;

FIG. 11 illustrates of an example of similar to those of FIGS. 9 and 10 except that the in-coupling grating and the out-coupling grating 104 are separated with a physical distance from the additional grating;

FIG. 12 illustrates of an example of propagation directions of two different wavelengths inside the lightguide;

FIG. 13 illustrates of an example of a flow chart of an operating method of a lightguide of an augmented or virtual reality eyewear apparatus; and

FIG. 14 illustrates of an example of a flow chart of a manufacturing method of a lightguide of an augmented or virtual reality eyewear apparatus.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features/structures that have not been specifically mentioned. All combinations of the embodiments are considered possible if their combination does not lead to structural or logical contradiction.

It should be noted that while Figures illustrate various embodiments, they are simplified diagrams that only show some structures and/or functional entities. The connections shown in the Figures may refer to logical or physical connections. It is apparent to a person skilled in the art that the described apparatus may also comprise other functions and structures than those described in Figures and text. It should be appreciated that details of some functions, structures, and the signalling and/or controlling are irrelevant to the actual invention. Therefore, they need not be discussed in more detail here.

In the prior art design, the locations of an in-coupling and out-coupling grating have certain, and in some cases serious, limitations. In this document, an additional exit pupil expander (EPE) i.e. additional grating is placed to a lightguide in such a way that the in-coupled light propagating inside the lightguide is directed towards EPE areas integrated together in order to form a single EPE structure, which further changes the propagating direction. Part of the light directed by said EPE may also go directly to the out-coupling grating. Using the additional EPE makes it possible to adjust the position of in-coupling grating more freely and/or control the total area covered by the gratings and/or the total area of the lightguide.

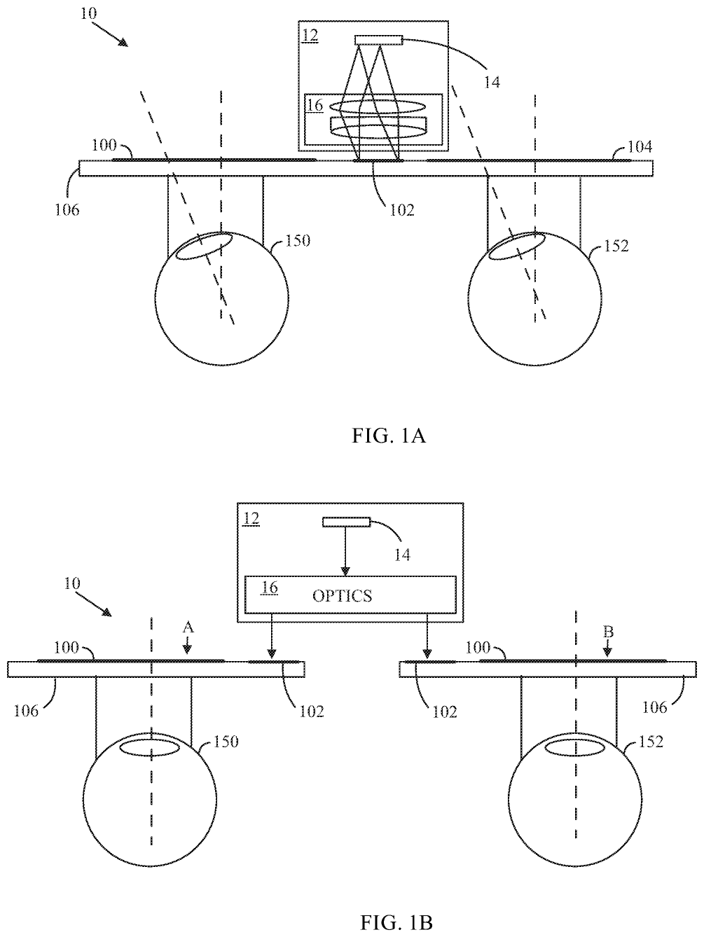

FIGS. 1A and 1B illustrate examples of an AR (Augmented Reality) or VR (Virtual Reality) eyewear 10. The eyewear 10 may look like glasses, spectacles or goggles, for example. In an embodiment, the eyewear may be in connection with a headwear like a cap, a hat or a helmet, for example. The eyewear may be a near-eye-display, a head mounted display, a wearable display, cinema glasses or smart glasses, for example.

In FIG. 1A, the eyewear 10 comprises a lightguide 106 and an image generating unit 12, which in turn may have an image source 14 and an optic component arrangement 16. The image generating unit 12 generates visible light of an image (still or video) that is coupled to the lightguide 106 through the optic component arrangement 16 and an in-coupling diffractive grating 102, which is on a surface of the lightguide 106.

In FIG. 1B, the eye wear comprises two parts A and B, each for one eye 150, 152. The image generating unit 12 may direct the visible light of the image to the optic component arrangement 16, which may split the light for the two parts A and B. Instead of optical splitting, the eyewear may have two image generating units 12, each for one part A and B. There are various possibilities to place or fix the image generation units 12 to the eyewear but they need not be discussed in more detail here.

The lightguide 106 allows visible light to propagate via total internal reflection from the in-coupling diffractive grating 102 to one or more first out-coupling diffractive gratings 100, 104. The lightguide 106 may be made up of a transparent material like glass, sapphire and/or a polymer, for example. The glass may comprise a high refractive index flint glass family, for example. A refractive index of the lightguide 106 may be from about 1.5 to about 2 or higher.

Instead of what is shown in FIGS. 1A and 1B, the augmented or virtual image of the eyewear 10 may be applied to a single eye only such that the lightguide 106 or an out-coupling grating is only in front of said one eye.

The visible light is thus guided laterally within the lightguide 106 based on vertical reflections and one or two of the out-coupling diffractive gratings 100, 104 couple the visible light out of the lightguide 106 in order direct the visible light into one or two eyes 150, 152 of a user for showing the image. The out-coupling diffractive gratings 100, 104 are used as optical combiners in the augmented reality eyewear. The user may namely see the environment through the lightguide 10 and the image diffracted from the first and second diffractive gratings 100, 104.

In an embodiment an example of which is illustrated in FIG. 1A, the eyewear has one lightguide 10 and one image generating unit 12 for both eyes 150, 152.

In an embodiment, the eyewear may have one lightguide 10 and one image generating unit 12 per one eye 150, 152.

The in- and out-coupling diffractive gratings 100 to 104 may be on a common side of the lightguide 106. In an embodiment, at least one of the diffractive gratings 100 to 104 may be on a side of the lightguide 106 opposite to at least one other of them.

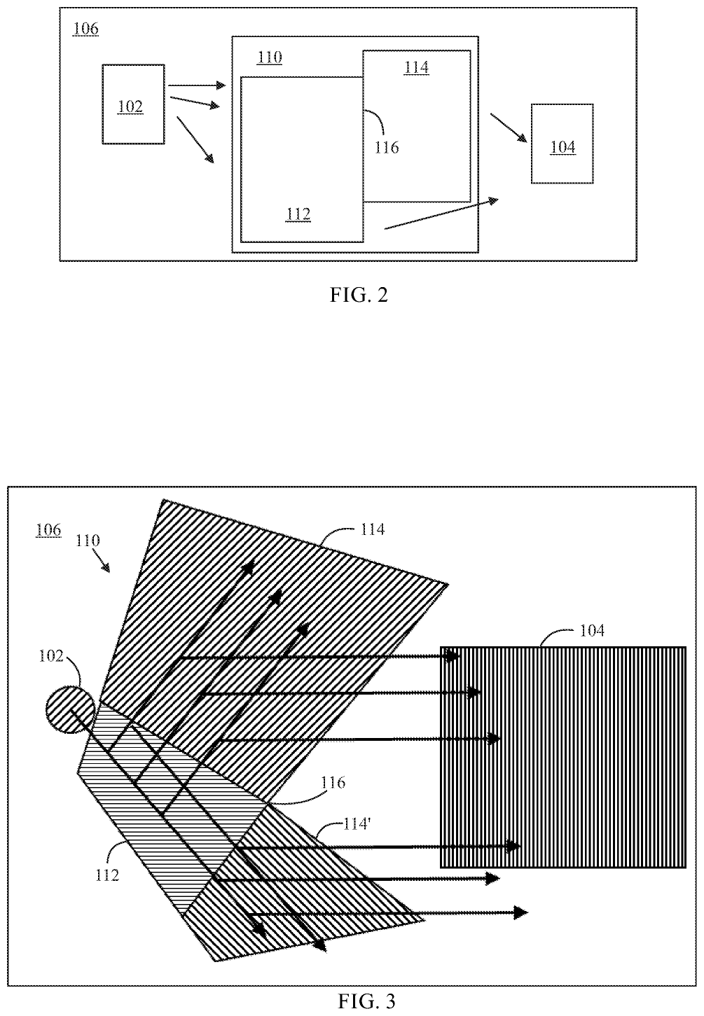

FIG. 2 illustrates an example of a lightguide 106 of an augmented or virtual reality eyewear apparatus 10 seen from above. The lightguide 106 comprises an additional grating 110 arranged between an in-coupling grating 102 and an out-coupling grating 104. The additional grating 110 may be single, integrated grating. That means that the additional grating 110 is not formed of separated pieces of gratings that are spaced apart from each other.

The additional grating 110 comprises a plurality of grating areas 112, 112′, 114, 114′, at least two grating areas 112, 112′, 114, 114′ of which have a common physical interface 116. The different grating areas 112, 112′, 114, 114′ also have grating vectors that point to different directions. In an embodiment, the grating vectors are not parallel i.e. they do not point toward a common direction and they do not point to opposite directions.

Each of the grating vectors of the additional grating 110, the in-coupling grating 102 and the out-coupling grating 104 are linear combinations of two non-parallel and common base vectors. The common base vectors are non-parallel to each other. The common base vectors are common to the single additional grating 112, 112′, 114, 114′, the in-coupling grating 102 and the out-coupling grating 104. A sum of the grating vectors of the in-coupling grating 102, the additional grating 110 and the out-coupling grating 104 is zero separately for each optical path, which guides light from the in-coupling grating 102 via the additional grating 110 to the out-coupling grating 104 and enable out-coupling of the light from the out-coupling grating 104.

In an embodiment, an angle between the directions of the base vectors is at least one of the following: 45°, 60° and 90°. In an embodiment, a value of a sine function of the angle or a square of a value of a sine function of the angle may have a rational value. Rational numbers are expressed as a quotient or fraction of two integers, p/q where p and q are integers.

In an embodiment, a first vector of the two base vectors may have a different magnitude from that of a second vector of the two base vectors.

In an embodiment, a linear combination of the base vectors is formed by multiplying at least one of the base vectors by a constant that may be an integer and adding the base vectors together. Then the linear combination of a first base vector a and a second base vector b will be k1*a+k2*b, where coefficients k1 and k2 may be integers: . . . −2, −1, 0, 1, 2, . . . . In an embodiment, the coefficients may be rational or real numbers.

In an embodiment, the additional grating 110 may comprise an array of the grating areas 112, 112′, 114, 114′ arranged in a successive manner in a direction of propagation light between an in-coupling grating 102 and an out-coupling grating 104. In an embodiment, light may return, at least partly, to a grating area again after having been diffracted to one or more grating areas or gratings. The grating areas 112, 112′ 114, 114′ may be turning points in propagation of light, which diffract at each grating area 112, 112′, 114, 114′ such that propagation of diffracted light has a directional component in the lateral direction of the lightguide 106. The array of the grating areas 112, 112′, 114, 114′ can be considered an ordered arrangement, which cooperates in order to have a desired outcome.

A first grating area 112,112′ of the array receives light from the in-coupling grating 102, and a last grating area 114, 114′ of the array forwards light to the out-coupling grating 104. In an embodiment, any grating area 112, 112′, 114, 114′ except the last grating area 114, 114′ of the array may pass on at least a portion of light received from a previous grating to a next grating or grating area. The previous grating may be the in-coupling grating 102 or a grating area. When light is forwarded from one kind of grating to at least one next kind of grating, it is sent or transmitted onward toward the at least one next grating area or grating.

In an embodiment as shown with arrows in FIG. 2, any grating area 112 except the last grating area 114 of the array may also additionally pass on a portion of light received from a previous grating to the out-coupling grating 104.

In an embodiment as shown with arrows in FIG. 2, for example, one or more grating areas 112 may cause light partially bypass one or more grating areas when forwarding light to a next grating or grating area. In an embodiment, one or more grating areas 112 except the last grating area 114 may cause light partially bypass one or more grating areas when forwarding light to a next grating or grating area.

FIG. 3 illustrates another example of the lightguide 106 of the augmented or virtual reality eyewear apparatus 10 seen from above. In this example, the in-coupling grating 102 diffracts light toward a first grating area 112 which diffracts a part of the light toward a second grating area 114 which is the last grating area before the out-coupling grating 104. The three grating areas 112 114, 114′ have different grating angles i.e. directions of their lines are different. The second grating area 114 diffracts the light it receives from the first grating area 112 toward the out-coupling grating 104. In this example, the first grating area 112 allows a part of the light that is directed thereto from the in-coupling grating 102 to travel through to a third grating area 114′ which is beside the second grating area 114. The third grating area 114′ diffracts the light it receives from the first grating area 112 toward the out-coupling grating 104. In this configuration, light may travel in parallel paths.

The additional grating 110 may also be called a fold grating. The array causes light to turn at least once in a lateral direction in the optical path from the in-coupling grating 102 to the out-coupling grating 104, the lateral direction being perpendicular to a direction of thickness of the lightguide 106.

In an embodiment examples which are shown in FIGS. 3 to 6, the array may comprise at least two grating areas 112, 112′114, 114′ each of which may cause light to turn or diffract in a lateral direction in the optical path from the in-coupling grating 102 to the out-coupling grating 104. The arrows in FIGS. 3 to 6 and 8 illustrate the propagation of light inside the lightguide 106.

In an embodiment, the in-coupling grating 102 may turn light to deviate away from a direction parallel with a straight line between the in-coupling grating 102 and the out-coupling grating 104 while directing light to a first grating 112.

In an embodiment, at least one of the at least two grating areas 112, 112′, 114, 114′ may turn light to deviate away from a direction parallel with a straight line between the in-coupling grating 102 and the out-coupling grating 104.

Light travels a zig-zag path within the lightguide 106, the zig-zag path having a directional component parallel to a lateral direction of the lightguide 106. The array thus causes light to turn at least once in a lateral direction in the optical path from the in-coupling grating 102 to the out-coupling grating 104, the lateral direction being perpendicular to a direction of a vertical thickness of the lightguide 106.

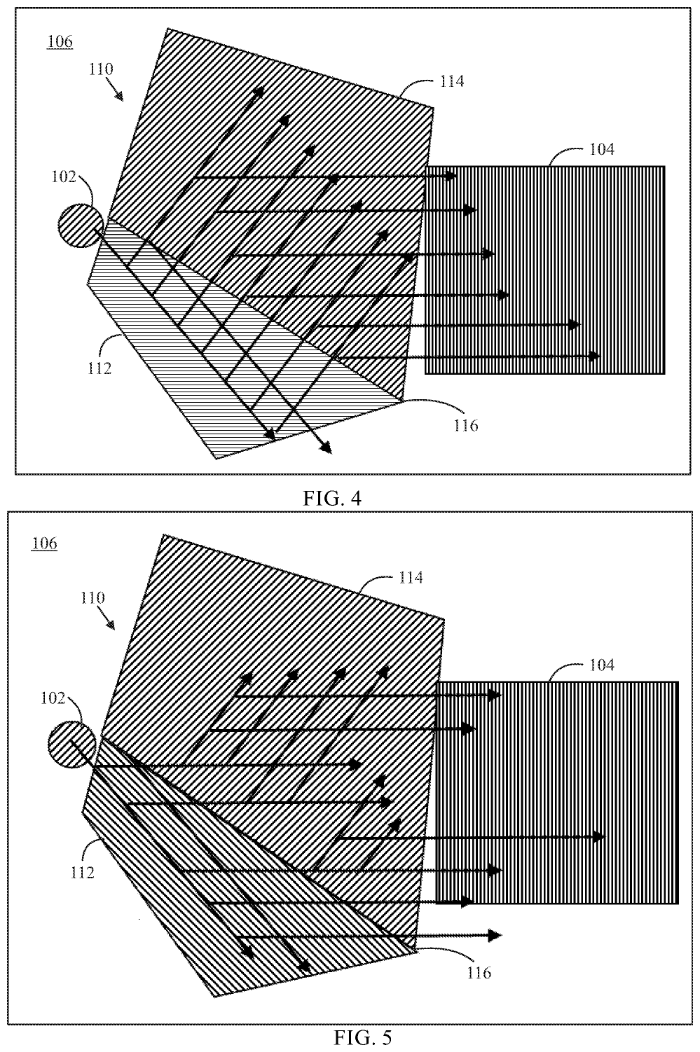

Some additional variations of the grating areas 112, 112′, 114, 114′ are illustrated in FIGS. 4 to 6. FIG. 4 illustrates an example of a layout of the lightguide 106 that has two grating areas 112, 114, and a first grating area 112 turns light towards a last grating area 114 which then turns light towards out-coupling grating 104.

FIG. 5 illustrates an example that is similar to that of FIG. 4. In this example, a first grating area 112 turns light towards an out-coupling grating 104 and a last grating area 114 further expands the beams that propagate through it before they turned to the out-coupling grating 104.

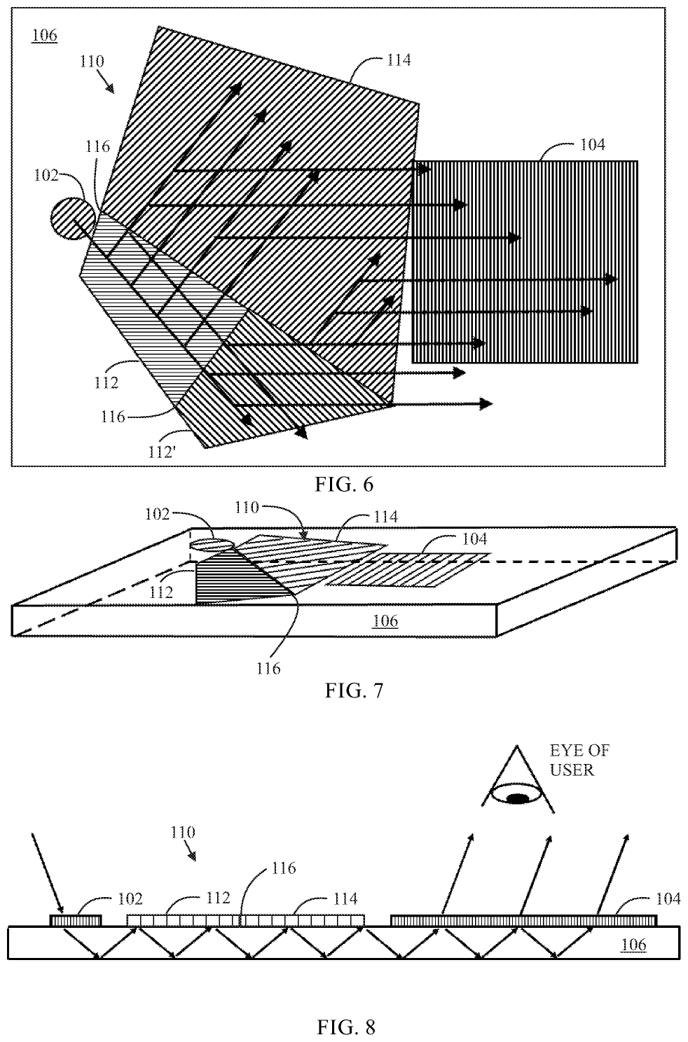

FIG. 6 illustrates an example of a combination of the two previous cases shown in FIGS. 4 and 5. In all these cases the shapes and areas of the additional grating 110 and the grating areas 112,112′, 114, 114′ may be adjusted as well as the positions of in-coupling grating 102 and the out-coupling grating 104.

The grating periods and angles may also be chosen such that there is a limited number of propagation directions for the rays coupled into the lightguide 106 in a certain angle. Hence, the linear combination may be based on integer constants. In this manner, quality of the image is good and ghost images may be limited or eliminated.

In an embodiment, orientation of the in-coupling grating 102, the additional grating 110 and the out-coupling gratings 104, and a geometrical surface parameter of the lightguide 106 may be optimized with respect to each other. In an embodiment, orientation of the in-coupling grating 102, at least one of the grating areas 112, 112′, 114, 114′ and the out-coupling gratings 104, and a geometrical surface parameter of the lightguide 106 may be optimized with respect to each other. The surface parameter can be considered a characteristic or feature of the surface. The geometrical surface parameter may be one of the following: an area and a shape.

Directions of the grating ridges and/or the grating grooves determine the direction of the diffracted light both vertically and laterally when the direction of light to a grating is known. Another parameter is density of the grating ridges and/or grating grooves, which defines at what angle in the vertical and lateral directions the light diffracts from a grating. These parameters are limited by the fact that only a predetermined range of angles of light in the vertical direction results in a total internal reflection. In that manner, it is possible to design and determine various desired paths of light through the lightguide 106. The height, width and/or the profile shape of the grating lines may also vary in order to have a desired propagation of light in the waveguide 106 and/or to enable a design target of the waveguide 106.

In an embodiment, a number of the grating areas 112, 112′, 114, 114′ and the geometrical surface parameter of the lightguide 106 may be optimized with respect to each other. The higher the number of the grating areas 112, 112′, 114, 114′ the more independently and effectively the locations of the in-coupling grating 102 and the out-coupling grating 104 can be set, but an increasing number of the grating areas 112, 112′, 114, 114′ may also increase area of the waveguide 106. In order to keep the area optimized, also other parameters such as direction of ridges, density of ridges, shape and a total area of the grating areas 112, 112′, 114, 114′ should be considered.

In an embodiment, density of lines i.e. a number of lines per unit of length of the grating areas 112, 112′, 114, 114′ and the geometrical surface parameter of the lightguide 106 may be optimized with respect to each other. The lines can be understood to mean a grating ridge or a grating groove. Sometimes an acute bending angle of rays of light may be useful while in some other cases an obtuse angle may be more desired.

In an embodiment, the number of the grating areas 112, 112′, 114, 114′, the density of lines and the geometrical surface parameter of the lightguide 106 may be optimized with respect to each other.

In an embodiment, a shape of the additional grating 110 and the geometrical surface parameter of the lightguide 106 may be optimized with respect to each other. A shape of the additional grating may be polygonal, circular or ellipsoidal, for example. In an embodiment, a shape of the grating areas 112, 112′, 114, 114′ and the geometrical surface parameter of the lightguide 106 may be optimized with respect to each other. A shape of a grating area 112, 112′, 114, 114′ may be polygonal, circular or ellipsoidal, for example.

That is, a location of the in-coupling grating 102 and a location of the out-coupling grating 104 may adjusted and set in a desired manner with respect to each other based on direction of the grating ridges/grooves, density of grating ridges/grooves of the additional grating 110 and the grating areas 112, 112′, 114, 114′ while a shape and/or area of the lightguide is predetermined.

FIG. 8 illustrates an example of operation of the lightguide 106 seen from side. Light zig-zags in a vertical direction (parallel to thickness of the lightguide 106) because of total internal reflection. Light also zig-zags in a lateral direction (perpendicular to thickness of the lightguide 106) because of diffraction from and between the grating areas 112, 112′, 114, 114′ as can also be seen in FIGS. 2 to 7.

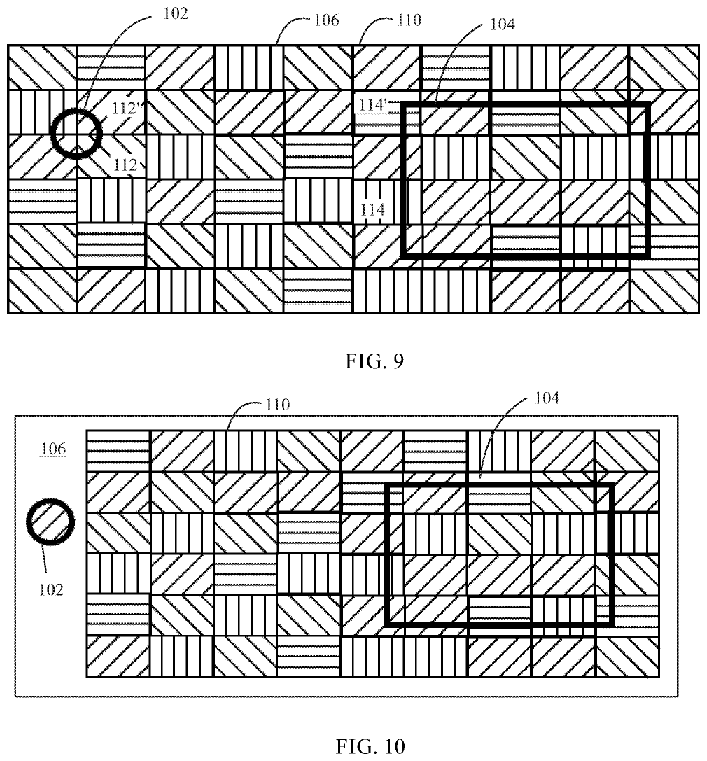

FIG. 9 illustrates an example where the lightguide 106 comprises a plurality of grating areas 112, 112′, 114, 114′ hatched in different directions in order to illustrate different directions of the grating vectors. Directly adjacent grating areas 112, 112′, 114, 114′ are directly connected to each other such that they have a common interface 116. That is, there is no physical, material or optical structure between them, which is what the common interface requires. A plurality of grating areas may be between the in-coupling grating 102 and the out-coupling grating 104 (that is why only grating areas 112, 112′ and 114, 114′ are shown in conjunction with the in-coupling grating 102 and the out-coupling grating 104, respectively).

FIG. 10 illustrates an example similar to that of FIG. 9 except that the in-coupling grating 102 is separated with a physical distance from the additional grating 110 and the out-coupling grating 104.

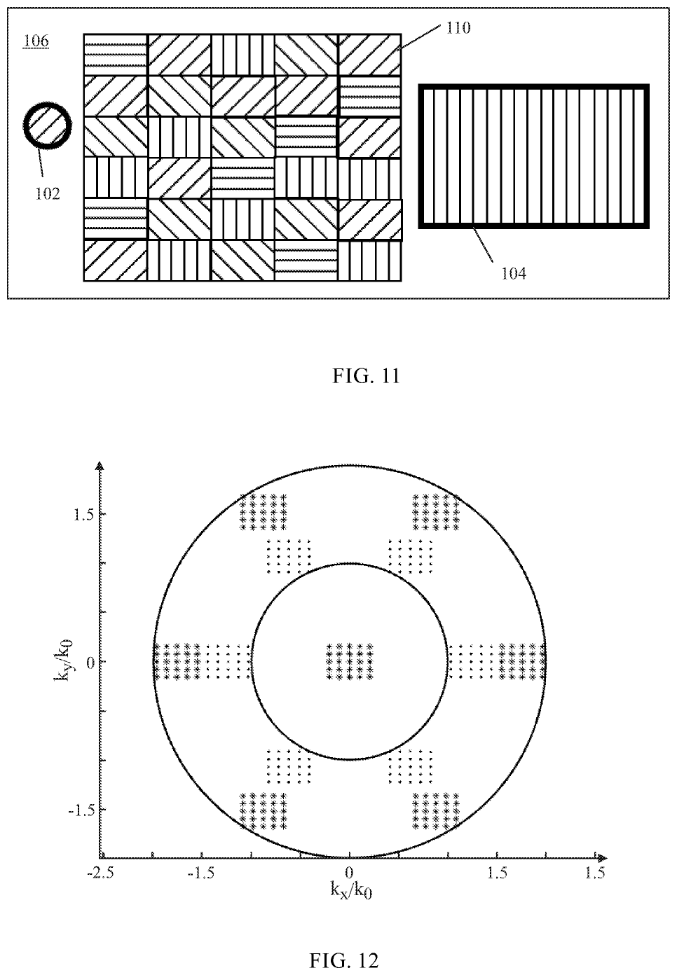

FIG. 11 illustrates a further example similar to those of FIGS. 9 and 10 except that the in-coupling grating 102 and the out-coupling grating 104 are separated with a physical distance from the additional grating 110.

FIG. 12 illustrates an example of propagation directions of two different wavelengths in a wave vector space of the lightguide 106. The vertical axis is a relative wave number in a y-direction and the horizontal axis is a relative wavenumber in an x-direction. The light comes in at the origin, which is in middle of the circles, and it diffracts toward one of the allowed six directions when interacting with a grating area. The six allowed directions are possible within the lightguide 106 in this example, because different grating areas may have grating vectors in different directions. When the diffracted light remains within the annulus (between two concentric circles), it can propagate within the lightguide 106. Each dot represents a certain propagation direction within the lightguide 106. The larger dots in FIG. 12 denote light of a long wavelength (red for example) and the smaller dots denote light of a short wavelength (blue for example).

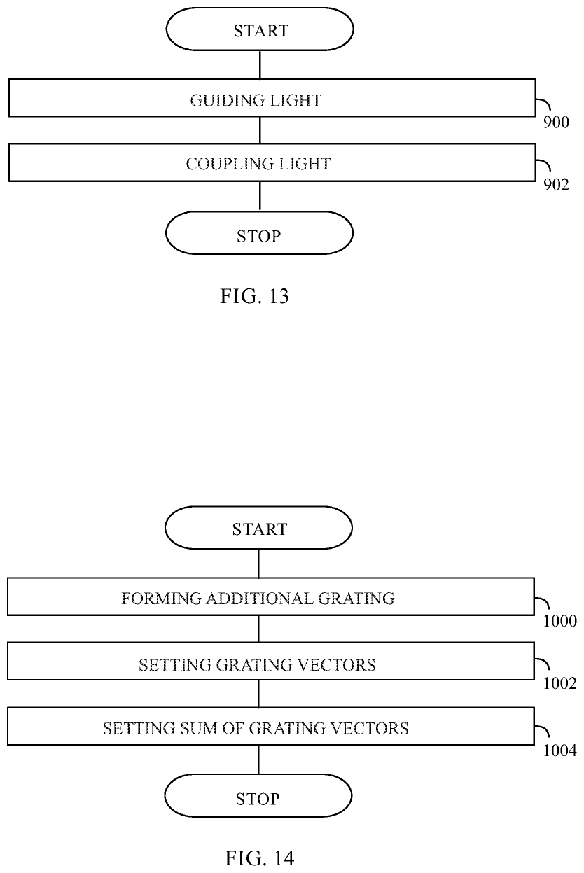

FIG. 13 is a flow chart of the operation method of a lightguide 106 of an augmented or virtual reality eyewear apparatus 10. In step 900, light is guided in each optical path within a lightguide 106, which has an in-coupling grating 102, an out-coupling grating 104 and an additional grating 110, from the in-coupling grating 102 via a plurality of grating areas 112, 112′, 114, 114′ of the additional grating 110, at least two of the grating areas 112, 112′, 114, 114′ of which have a common physical interface 116 and grating vectors of different directions, to the out-coupling grating 104. In step 902, said light of the each optical path is coupled out from the out-coupling grating 104. In these steps, each of the grating vectors of the additional grating 110, the in-coupling grating 102 and the out-coupling grating 104 are linear combinations of two non-parallel and common base vectors, and a sum of the grating vectors of the in-coupling grating 102, the additional grating 110 and the out-coupling grating 104 is zero separately for said each optical path.

FIG. 14 is a flow chart of the manufacturing method of a lightguide 106 of an augmented or virtual reality eyewear apparatus 10. In step 1000, an additional grating 110 is formed with a plurality of grating areas 112, 112′, 114, 114′, at least two grating areas 112, 112′, 114, 114′ which have a common physical interface 116 and grating vectors of different directions, between an in-coupling grating 102 and an out-coupling grating 104.

In step 1002, each of the grating vectors of the additional grating 110, the in-coupling grating 102 and the out-coupling grating 104 are set to be linear combinations of two non-parallel and common base vectors. In step 1004, a sum of the grating vectors of the in-coupling grating 102, the additional grating 110 and the out-coupling grating 104 is set to be zero separately for each optical path, which is configured guide light from the in-coupling grating 102 via the additional grating 110 to the out-coupling grating 104 and couple the light out from the out-coupling grating 104.

Exit-pupil expanders (EPEs), which are additional gratings 110, could have been used in a lightguide 106 to distribute in-coupled light over a larger area before out-coupling but it required more space and material because of physical separation therebetween. This document describes a single additional EPE grating 110 with a plurality of grating areas 112, 112′, 114, 114′ which are placed in such a way that the in-coupled light propagating inside the lightguide 106 is at least partly directed by it towards another EPE area before entering the out-coupling grating 104. This kind of arrangement of an additional grating 110 gives more freedom to design and arrangement of the grating areas in the lightguide 106, thus allowing lightguide layouts which are more compact and fit better in the desired frames of the AR/MR glasses. This additional grating 110 may also be used to reduce the required surface area.

It will be obvious to a person skilled in the art that, as technology advances, the inventive concept can be implemented in various ways. The invention and its embodiments are not limited to the example embodiments described above but may vary within the scope of the claims.

1. A lightguide of an augmented or virtual reality eyewear apparatus, comprising:
an additional grating arranged between an in-coupling grating and an out-coupling grating wherein the additional grating comprises an array of a plurality of grating areas arranged in a successive manner in a direction of propagation light between the in-coupling grating and the out-coupling grating, a first grating area of the array being configured to receive light from the in-coupling grating, a last grating area of the array being configured to forward light to the out-coupling grating (104);
any grating area except the last grating area of the array being configured to pass on light received from a previous grating to at least one next additional grating;
at least two grating areas have a common physical interface by being directly connected to each other and grating vectors of different directions; and
the in-coupling grating and the out-coupling grating are linear combinations of two non-parallel and common base vectors, and a sum of the grating vectors of the in-coupling grating, the additional grating and the out-coupling grating is zero separately for each optical path, which is configured to guide light from the in-coupling grating via the additional grating to the out-coupling grating and enable out-coupling of the light from the out-coupling grating.

2. The apparatus of claim 1, wherein an angle between the directions of the base vectors is at least one of the following: 45°, 60° and 90°.

3. The apparatus of claim 1, wherein a first vector of the two base vectors has a different magnitude from that of a second vector of the two base vectors.

4. The apparatus of claim 1, wherein a linear combination of the base vectors is formed by multiplying at least one of base vectors by an integer and adding the base vectors together.

5. The apparatus of claim 1, wherein the array comprises at least two grating areas each configured to cause light to turn in a lateral direction in the optical path from the in-coupling grating to the out-coupling grating (104).

6. The apparatus of claim 1, wherein orientation of the in-coupling grating, the additional grating, and a geometrical surface parameter of the lightguide are optimized with respect to each other.

7. The apparatus of claim 1, wherein the geometrical surface parameter is one of the following: an area and a shape.

8. The apparatus of claim 1, wherein a number of the grating areas and the geometrical surface parameter of the lightguide are optimized with respect to each other.

9. The apparatus of claim 1, wherein density of lines of the grating areas and the geometrical surface parameter of the lightguide are optimized with respect to each other.

10. The apparatus of claim 1, wherein a shape of the additional grating and the geometrical surface parameter of the lightguide are optimized with respect to each other.

11. An augmented or virtual reality eyewear apparatus, comprising:
a lightguide comprising an additional grating arranged between an in-coupling grating and an out-coupling grating; wherein the additional grating comprises an array of a plurality of the grating areas arranged in a successive manner in a direction of propagation light between the in-coupling grating and the out-coupling grating, a first grating area of the array being configured to receive light from the in-coupling grating, a last grating area of the array being configured to forward light to the out-coupling grating;
any grating area except the last grating area of the array being configured to pass on light received from a previous grating to at least one next additional grating;
at least two grating areas have a common physical interface by being directly connected to each other and grating vectors of different directions; and
the in-coupling grating and the out-coupling grating are linear combinations of two non-parallel and common base vectors, and a sum of the grating vectors of the in-coupling grating, the additional grating and the out-coupling grating is zero separately for each optical path, which is configured guide light from the in-coupling grating via the additional grating to the out-coupling grating and couple the light out from the out-coupling grating.

12. An operational method of a lightguide of an augmented or virtual reality eyewear apparatus, comprising:
guiding light in each optical path within a lightguide, which has an in-coupling grating, an out-coupling grating and an additional grating, which comprises an array of a plurality of the grating areas arranged in a successive manner in a direction of propagation light between the in-coupling grating and the out-coupling grating, from the in-coupling grating via a plurality of grating areas of the additional grating to the out-coupling grating, at least two of the grating areas having a common physical interface based on direct connection to each other and grating vectors of different directions, by receiving, by a first grating area of the array, light from the in-coupling grating, and forwarding, by a last grating area of the array, light to the out-coupling grating;
passing on, by any grating area except the last grating area of the array, light received from a previous grating to at least one next additional grating; and
coupling said light of the each optical path out from the out-coupling grating, where the in-coupling grating and the out-coupling grating are linear combinations of two non-parallel and common base vectors, and a sum of the grating vectors of the in-coupling grating, the additional grating and the out-coupling grating is zero separately for said each optical path.

13. A manufacturing method of a lightguide of an augmented or virtual reality eyewear apparatus, comprising:
forming an additional grating with an array of a plurality of grating areas arranged in a successive manner in a direction of propagation light between the in-coupling grating and the out-coupling grating, a first grating area of the array being configured to receive light from the in-coupling grating, a last grating area of the array being configured to forward light to the out-coupling grating such that at least two grating areas have a common physical interface based on direct connection to each other and grating vectors of different directions, any grating area except the last grating area of the array being configured to pass on light received from a previous grating to at least one next additional grating;
setting each of the grating vectors of the additional grating, the in-coupling grating and the out-coupling grating to be linear combinations of two non-parallel and common base vectors; and
setting a sum of the grating vectors of the in-coupling grating, the additional grating and the out-coupling grating to be zero separately for each optical path, which is configured guide light from the in-coupling grating via the additional grating to the out-coupling grating and couple the light out from the out-coupling grating.

14. The method of claim 13, the method comprising optimizing orientations of the in-coupling grating, the additional grating and the out-coupling gratings, and a geometrical surface parameter of the lightguide with respect to each other.
